(19) United States
(12) Patent Application Publication
(10) Pub. No.: US 2018/0281119 A1
(43) Pub. Date: Oct. 4, 2018

(54) PIPE CRAWLING WELDING DEVICE AND METHOD OF WELDING PIPES WITH SUCH DEVICE

(71) Applicant: ESAB AB, Goteborg (SE)

(72) Inventor: Arne LAGERKVIST, Goteborg (SE)

(21) Appl. No.: 15/936,705

(22) Filed: Mar. 27, 2018

Related U.S. Application Data
(63) Continuation of application No. PCT/EP2015/073181, filed on Oct. 7, 2015.

(51) Int. Cl. B23K 37/02; B23K 37/053; B23K 9/028

(52) U.S. Cl. CPC B23K 37/0276; B23K 37/0282; B23K 2201/10; B23K 37/0531; B23K 9/0284; B23K 37/0294

(57) ABSTRACT

A pipe crawling welding device including a crawler module having a propulsion unit configured to controllably drive the device longitudinally through a pipe. The device may further include a welding module that is rotatably coupled to the crawler module and has a welding head mounted thereon, wherein the welding module automatically rotates in an opposite direction and at a same rotational speed relative to a direction and rotational speed of the crawler module to maintain an angular position of the welding head.

### CROSS-REFERENCE TO RELATED APPLICATIONS

This is a Continuation of PCT/EP2015/073181 filed on Oct. 7, 2015, which is incorporated by reference herein in its entirety.

### FIELD OF THE DISCLOSURE

Embodiments of the present disclosure relate generally to the field of welding devices, and more particularly to a pipe crawling device that is adapted to weld pipe segments from the inside.

### BACKGROUND OF THE DISCLOSURE

Modern devices for performing submerged arc welding (SAW) within long segments of pipe often employ welding heads that are mounted on large, cantilevered static booms that are adapted to extend deep into pipe segments that are to be welded from the inside. For example, in order to weld two segments of pipe together in an axially abutting relationship, the boom of a conventional SAW device is extended longitudinally entirely through one of the pipe segments in order to position a welding head adjacent a joint between the abutting segments. It is therefore necessary for the boom to be at least as long as, or nearly as along as, the shorter of the two pipe segments to reach the joint.

SAW devices of the type described above are associated with a number of shortcomings. For example, the booms of such devices are generally quite long (e.g., over 10 meters), and therefore require a great deal of floor space within an operating environment, such as in a manufacturing facility, onboard a vessel, or in other settings in which space is at a premium. Furthermore, these types of SAW devices are generally very heavy (e.g., over 5000 kg), which can be disadvantageous in certain operating environments, such as onboard seafaring vessels, in which weight also comes at a premium. Still further, these types of devices are susceptible to vibration, which can be highly detrimental to the quality of a weld, thereby necessitating additional support structures positioned proximate a weld while the weld is applied. Still further, these types of devices can only be used with a certain length of pipe because the booms bend under their own weight and the weight of the welding head, which can cause alignment problems.

In view of the forging, it would be desirable to provide a SAW device for welding the interiors of elongated pipe segments wherein such device is relatively compact, lightweight, and inexpensive. It would further be desirable to provide such a SAW device that is not susceptible to significant vibration during a welding operation.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments of the present disclosure are generally directed to a pipe crawling welding device. One exemplary embodiment of the pipe crawling welding device may include a crawler module having a propulsion unit configured to controllably drive the device longitudinally through a pipe. The device may further include a welding module that is rotatably coupled to the crawler module and has a welding head mounted thereon, wherein the welding module automatically rotates in an opposite direction and at a same rotational speed relative to a direction and rotational speed of the crawler module to maintain an angular position of the welding head.

A method for operating the pipe crawling welding device of the present disclosure may include positioning a welding head of the device adjacent an annular joint between axially abutting first and second pipes, securing a crawler module of the device against rotational movement relative to the first pipe, activating the welding head, rotating the first and second pipes at a first speed and in a first direction about a common axis, and rotating the welding head about the common axis at a second speed that is equal to the first speed and in a second direction that is opposite the first direction to maintain an angular position of the welding head.

### BRIEF DESCRIPTION OF THE DRAWINGS

By way of example, specific embodiments of the disclosed device will now be described, with reference to the accompanying drawings, in which:

FIG. 1 is a perspective view illustrating an exemplary pipe crawling welding device in accordance with the present disclosure;

FIG. 2 is side view of a roller unit of the pipe crawling welding device shown in FIG. 1;

FIG. 3 is perspective detail view illustrating a roller unit of the pipe crawling welding device shown in FIG. 1;

FIG. 4 is perspective detail view illustrating a welding module of the pipe crawling welding device shown in FIG. 1;

FIG. 5 is front perspective detail view illustrating a rotational coupling between a welding module and a crawler module of the pipe crawling welding device shown in FIG. 1;

FIG. 6 is rear perspective detail view illustrating a rotational coupling between a welding module and a crawler module of the pipe crawling welding device shown in FIG. 1;

FIG. 7 is side view illustrating the pipe crawling welding device of FIG. 1 connected to various material, power, and data communication feeds;

FIG. 8 is a flow diagram illustrating an exemplary method of using the pipe crawling welding device shown in FIG. 1; and

FIGS. 9a-d are a series of schematic views illustrating several of the method steps set forth in the flow diagram of FIG. 8.

FIG. 10 is a cross sectional side view illustrating the pipe crawling welding device of FIG. 1 with an optional clamping module attached to the crawler module.

### DETAILED DESCRIPTION

A device and method in accordance with the present disclosure will now be described more fully hereinafter with reference to the accompanying drawings, in which preferred embodiments of the device and method are shown. The disclosed device and method, however, may be embodied in many different forms and should not be construed as being limited to the embodiments set forth herein. Rather, these embodiments are provided so that this disclosure will be thorough and complete, and will fully convey the scope of the device and method to those skilled in the art. In the drawings, like numbers refer to like elements throughout.

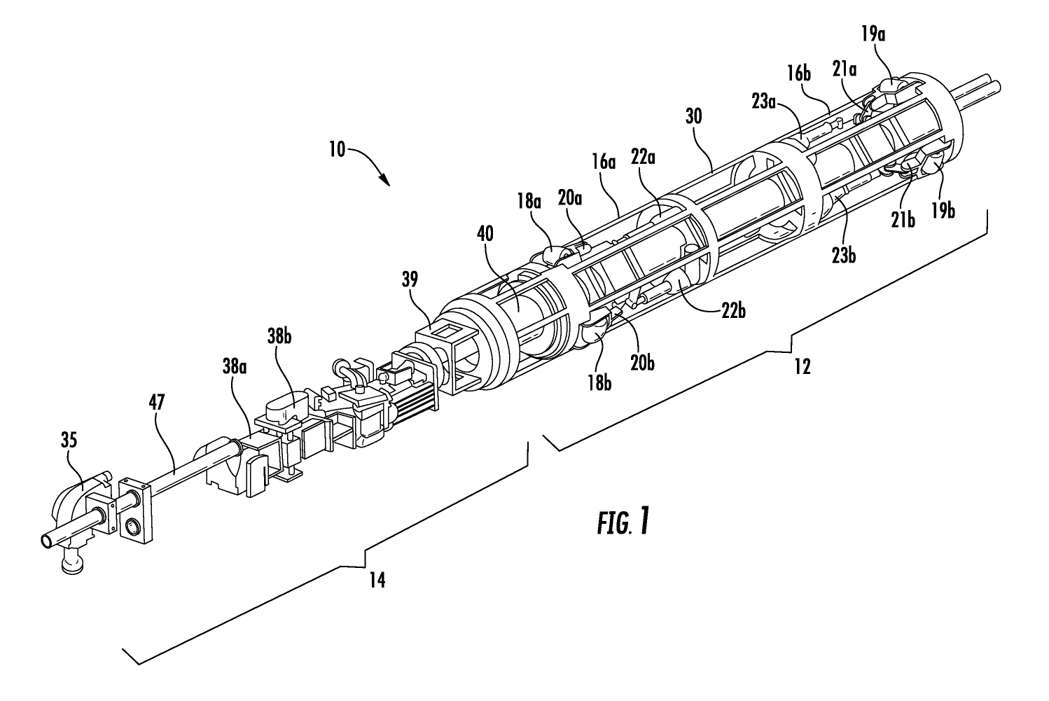

Referring to FIG. 1, an exemplary embodiment of a pipe crawling welding device 10 (hereinafter “the device 10”) in accordance with the present disclosure is shown. For the sake of convenience and clarity, terms such as “front,” “rear,” “top,” “bottom,” “upper,” “lower,” “vertical,” “horizontal,” “lateral,” “longitudinal,” “height,” and “width” may be used herein to describe the relative placement and orientation of the device 10 and its various components, each with respect to the geometry and orientation of the device 10 as it appears in FIG. 1. Particularly, the longitudinal end of the device 10 nearer the lower left corner of FIG. 1 shall be referred to as the “front” of the device and the longitudinal end of the device nearer the upper right corner of FIG. 1 shall be referred to as the “rear” of the device. Said terminology will include the words specifically mentioned, derivatives thereof, and words of similar import.

As shown in FIG. 1, the device 10 may include a generally cylindrical crawler module 12 that is rotatably coupled at its front end to a welding module 14 as further described below. The device 10 may have a size and shape that are suitable for insertion longitudinally into a pipe section that is to be welded. For example, the device 10 may have a largest outer diameter in a range between 100-500 millimeters to accommodate most internal welding applications, though it is contemplated that the device 10 may be made smaller or larger (e.g., having a largest outer diameter up to or exceeding 1500 millimeters) to suit other welding applications without departing from the scope of the present disclosure.

The crawler module 12 may be provided with roller units 16a, 16b located adjacent the front and rear ends of the crawler module 12, respectively. The roller units 16a, 16b may be adapted to concentrically center the device 10 within a pipe section while allowing the device 10 to move longitudinally through the pipe as further described below. The roller units 16a, 16b may be provided with respective sets of positioning wheels 18a, 18b, 18c and 19a, 19b, 19c, wheel arms 20a, 20b, 20c and 21a, 21b, 21c, and drive mechanisms 22a, 22b, 22c and 23a, 23b, 23c. Wheels 18c,19c, wheel arms 20c, 21c, and drive mechanisms 22c, 23c are not within view but are substantially identical to respective positioning wheels 18a, 18b, 19a, 19b, wheel arms 20a, 20b, 21a, 21b, and drive mechanisms 22a, 22b, 23a, 23b.

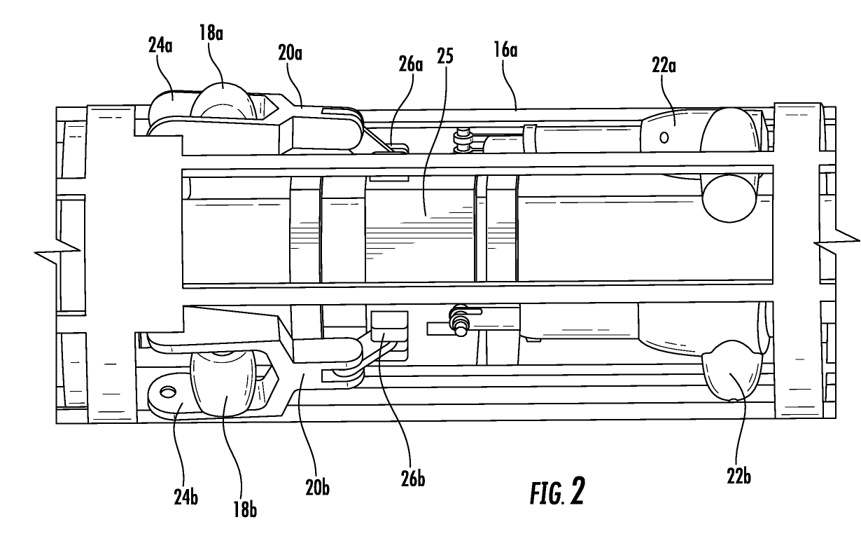

A detail view of the roller unit 16a is shown in FIG. 2. The roller unit 16b is substantially identical to the roller unit 16a, and it will therefore be understood that the following description of the roller unit 16a and its components shall apply equally to the roller unit 16b.

The wheel arms 20a-c of the roller unit 16a may be evenly spaced about a circumference of the crawler module 12 (or about an imaginary circumference of the crawler module 12 if the crawler module 12 does not have a circular cross section). The wheel arms 20a-c may have respective first ends 24a, 24b, 24c that may be pivotably coupled to a static frame portion 25 of the roller unit 16a. The positioning wheels 18a-c may be rotatably mounted to respective second ends 26a, 26b, 26c of the wheel arms 20a-c. The wheel arms 20a-c may be coupled to respective drive mechanisms 22a-c which may be adapted to controllably pivot the wheel arms 20a-c about their respective points of attachment to the frame portion 25, thereby selectively moving the positioning wheels 18a-c radially outwardly or inwardly relative to the frame portion 25. The positioning wheels 18a-c may thereby be controllably moved radially into and out of engagement with the interior surface of a pipe section as will be further described below. The drive mechanisms 22a-c may be any appropriate type of drive mechanisms that are suitable for controllably pivoting the wheel arms 20a-c, including, but not limited to, electric actuators, pneumatic actuators, and hydraulic actuators.

While the exemplary roller units 16a, 16b are shown in FIG. 1 as having three sets of positioning wheels 18a-c, 19a-c, wheel arms 20a-c, 21a-c, and drive mechanisms 22a-c, 23a-c, it is contemplated that the roller units 16a, 16b may be provided with additional sets of wheel arms, positioning wheels, and drive mechanisms without departing from the present disclosure. It is further contemplated that one or both of the roller units 16a, 16b may alternatively be provided with only a single drive mechanism that is adapted to simultaneously drive all of the respective wheel arms 20a-c, 21a-c. Moreover, while the crawler module 12 is shown in FIG. 1 as having two roller units 16a, 16b located adjacent the front and rear ends of the crawler module 12, it is contemplated that crawler module 12 may alternatively be provided with a greater or fewer number of roller units located at a variety of different positions along the crawler module 12.

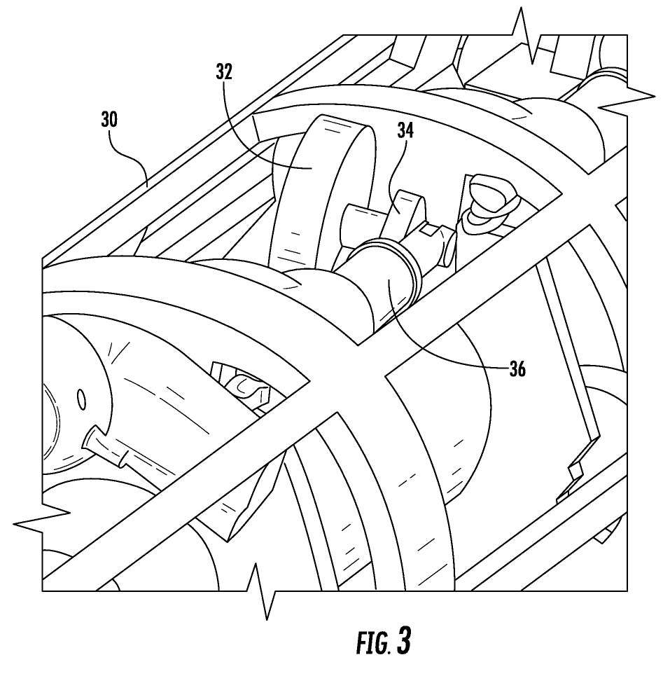

Referring again to FIG. 1, the crawler module 12 may include a propulsion unit 30 located intermediate the roller units 16a, 16b. The propulsion unit 30 may be adapted to controllably drive the device 10 longitudinally through a pipe section. For example, referring to the detailed view of the propulsion unit 30 shown in FIG. 3, the propulsion unit 30 may include a rotatably driven drive wheel 32 that may be mounted to a wheel arm 34. The wheel arm 34 may be coupled to a drive mechanism 36 for radially extending and retracting the wheel arm 34 relative to a static frame portion 37 of the propulsion unit in a manner similar to the wheel arms 20a-c described above. The drive wheel 32 may thereby be moved into and out of contact with the interior of a pipe section as will be further described below. The drive wheel 32 may be provided with a high-friction tread surface, such as may be formed of textured rubber or metal, for establishing a firm grip on the interior of a pipe section. The drive wheel 32 may further be provided with a brake mechanism (not shown) or a brake pad that may be controllably actuated for preventing unintended rotation of the drive wheel 32 to secure the longitudinal position of the device 10 within a pipe section.

The drive wheel 32 and the drive mechanism 36 of the propulsion unit 30 may be driven by electrical motors, compressed gas, etc., wherein the necessary electricity and/or gas may be supplied from sources (e.g., batteries, compressed gas cylinders, etc.) located onboard or external to the crawler module 12.

While the crawler module 12 is shown as having a single propulsion unit 30 with a single drive wheel 32 and wheel arm 34, it is contemplated that the crawler module 12 may be provided with additional propulsion units, and/or that the propulsion unit 30 may be provided with additional drive wheels and/or wheel arms without departing from the present disclosure. Additionally, it is contemplated that the drive wheel 32 and/or the wheel arm 34 may be replaced by, or supplemented with, any other type of structure or mechanism that can be adapted to controllably engage the interior of a pipe and forcibly move the device 10 longitudinally therethrough. Such structures and mechanisms may include, but are not limited to, rotatably driven tracks and belts. It is further contemplated that the propulsion unit 30 may be entirely omitted and that one of more of the positioning wheels 18a-c, 19a-c of the roller units 16a, 16b may be rotatably driven to move the device 10 longitudinally through a pipe section.

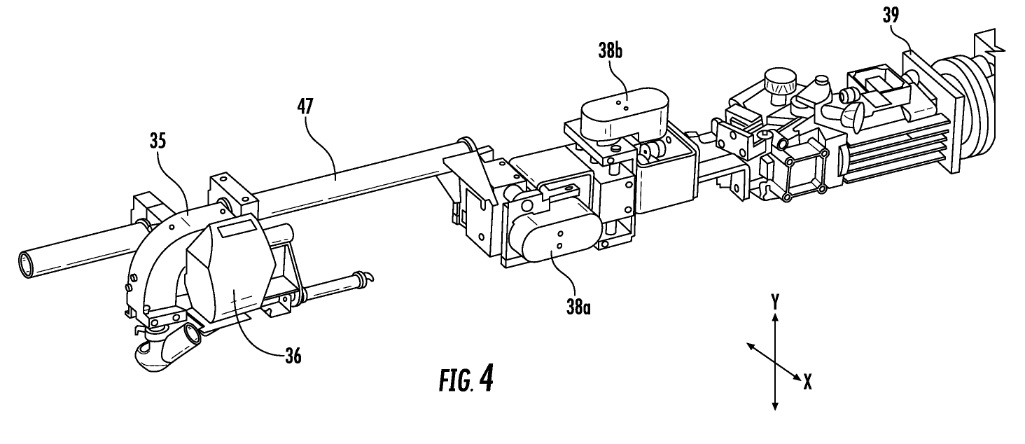

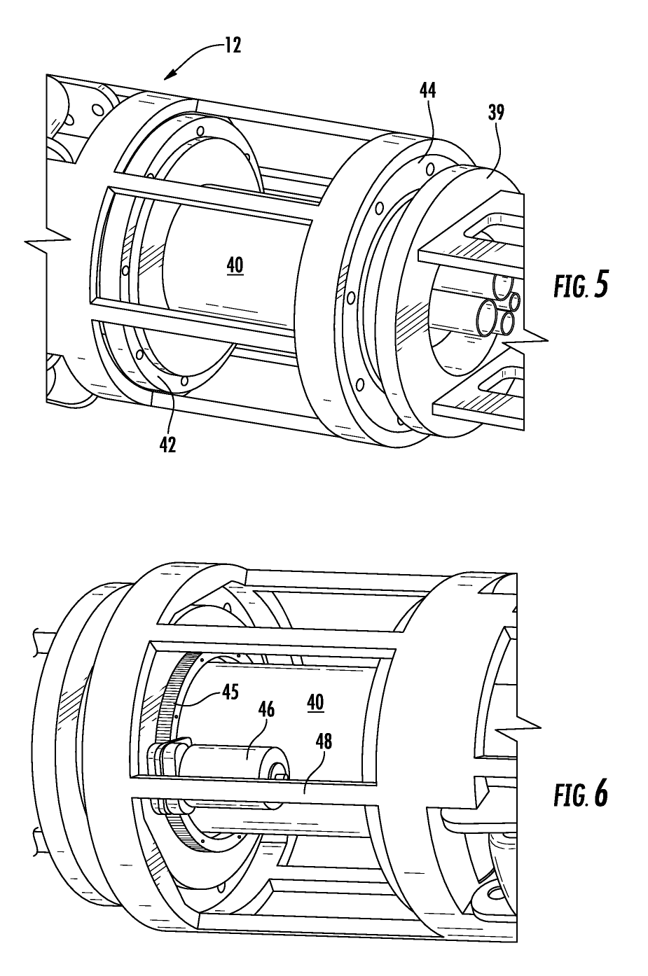

Referring to FIGS. 1 and 4, the welding module 14 of the device 10 may further include a welding head 35, a joint detection unit 36, cross slides 38a, 38b, and a mounting portion 39. As shown in FIG. 5, the mounting portion 39 of the welding module 14 may include a mounting shaft 40 that may be axially coupled to the crawler module 12 by an annular roller bearing joint 42 that allows free rotation of the welding module 14 relative to the crawler module 12 about a common longitudinal axis. The mounting shaft 40 may extend through an annular bearing 43 that is radially interposed between the mounting shaft 40 and a static annular cuff 44 at the front end of the crawler module 12. The mounting shaft 40 may have an outer diameter that is only slightly smaller than an inner diameter of the annular bearing 43, and thus the mounting shaft 40 may extend through the annular bearing 43 in a radially close clearance relationship therewith. The annular bearing 43 may limit radial movement of the mounting shaft 40 and may thereby mitigate vibration of the welding module 14 during operation while allowing free, axial rotation of the mounting shaft 40. It is contemplated that the annular roller bearing joint 42 and the annular bearing 43 may be, or may include, any type of suitable mechanical structures that facilitate the above-described rotation and support of the mounting shaft 40. Such mechanical structures include, but are not limited to, roller bearings, ball bearings, bushings, and the like.

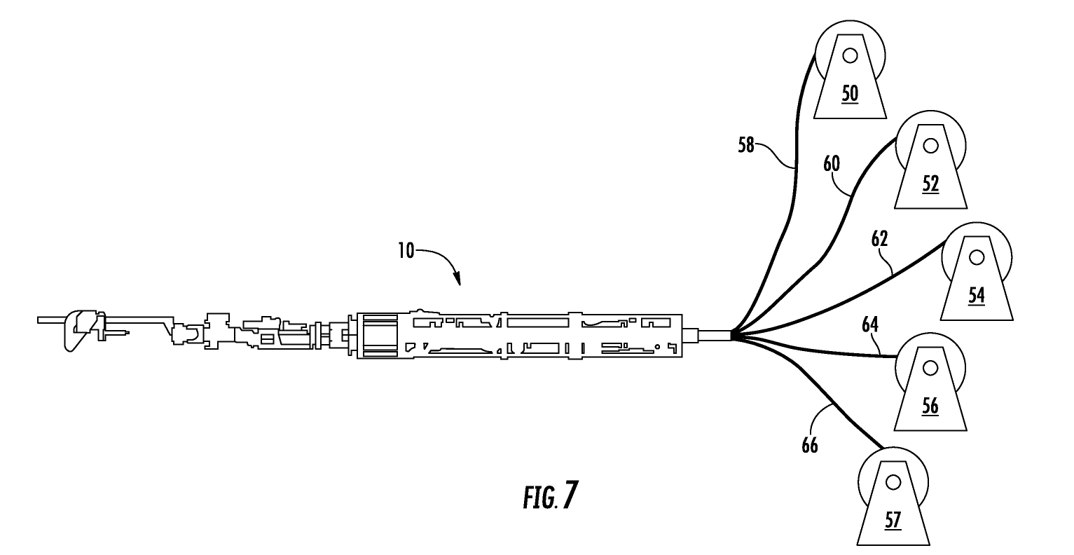

Referring to FIG. 6, a ring gear 45 may be formed or mounted on the mounting shaft 40. A motor 46, such as an electric servo motor, may be mounted to a static frame portion 48 of the front end of the crawler module 12. The motor 46 may be coupled to the ring gear 45 and may be operated to controllably rotate the ring gear 45, mounting shaft 40, and thus the entire welding module 14, relative to the crawler module 12 about a common longitudinal axis. In an exemplary embodiment of the present disclosure, the motor 46 may be coupled to a mechanism or controller that may be configured to automatically operate the motor 46 to rotate the welding module 14 in an opposite direction and at a substantially identical rate of speed relative to a direction and speed of rotation of the crawler module 12. In one contemplated embodiment, the mechanism or controller that dictates the operation of the motor 46 may be, or may include, a gyroscope to sense the angular position of the welding module 14. The motor 46 may thereby maintain an angular position of the welding module 14 regardless of the rotational speed and direction of the crawler module 12 as further described below.

Referring again to FIG. 4, the welding head 35 may be positioned at a front end of the welding module 14. For example, the welding head 35 may be removably mounted on a longitudinally-extending arm 47 at the front of the welding module 14. In one example, the welding head 35 may be a submerged arc welding (SAW) head that is adapted to controllably deliver a consumable electrode and a quantity of flux material to a welding area in a manner that will be familiar to those of ordinary skill in the art. However, it is contemplated that other types of welding heads may be substituted for the SAW head without departing from the present disclosure. Such alternative welding heads may be adapted to perform various welding processes including, but not limited to, metal inert gas (MIG) welding, tungsten inert gas (TIG) welding, flux-cored arc welding (FCAW), plasma arc welding (PAW), etc. While the welding module 14 is shown and described herein as having a single welding head 35, it is contemplated that the welding module 35 may include a plurality of welding heads arranged in a variety of configurations for suiting various applications, including but not limited to, circumferential welding applications and/or longitudinal welding applications as further described below.

The welding head 35 and the arm 37 may be coupled to the mounting portion 39 of the welding module 14 by the cross slides 38a, 38b. In one aspect of the present disclosure, the cross slides 38a, 38b may be substantially identical linear actuators that may be coupled to one another in an offset relationship. The cross slides 38a, 38b may be implemented using virtually any type of controllably-operated actuators, including, but not limited to, electric actuators, pneumatic actuators, and hydraulic actuators. The cross slides 38a, 38b may be operated to effectuate fine movement of the welding head 35 relative to the mounting portion 39 along transverse, respective axes of motion (e.g., the x and y axes shown in FIG. 4). The transverse and vertical positions of the welding head 35 relative to the longitudinal axis of the welding module 14 may thereby be controllably adjusted as further described below. Alternative embodiments of the welding module 14 are contemplated which include a cross slide that is substantially similar to the cross slides 38a, 38b, but that is oriented to facilitate fine longitudinal movement of the welding head 35 along the z axis shown in FIG. 4.

The joint detection unit 36 may be mounted on or adjacent to the welding head 35 and may be configured to detect an interior joint or seam between longitudinally-abutting segments of pipe. The joint detection unit 36 may be implemented using any suitable mechanical, electrical, and/or optical sensor or detector. In one example, the joint detection unit 36 may be, or may include, a video camera which may communicate a recorded image to a remote operator interface as further described below. In other examples, the joint detection unit 36 may be, or may include, a laser or a photodetector which may be adapted to detect a joint. Still further, the joint detection unit may be, or may include, a mechanical seam tracking finger.

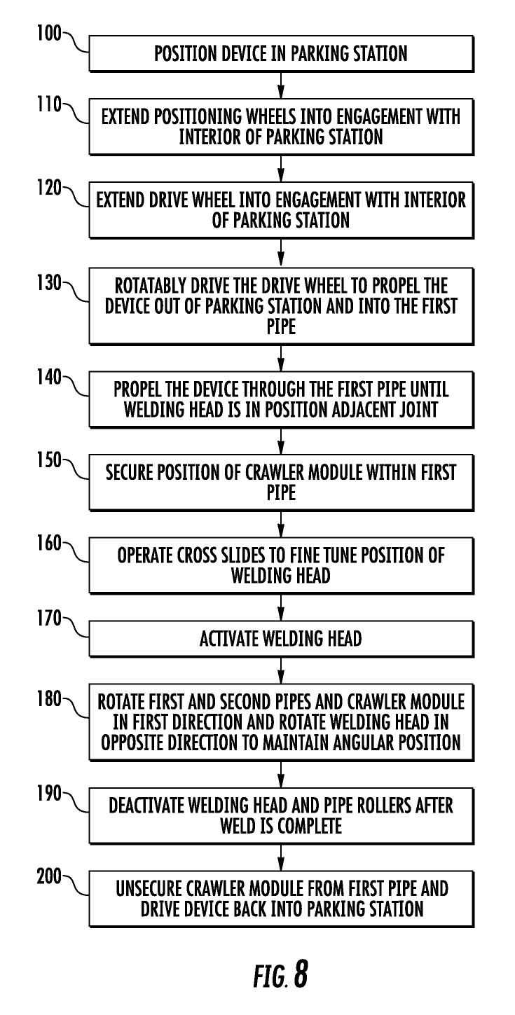

Referring to the side view of the device 10 shown in FIG. 7, a plurality of reels 50, 52, 54, 56, 57 may be located at fixed positions adjacent to one end of the device 10 (e.g., on the floor of a manufacturing facility or on the deck of a vessel). These reels 50-57 may supply the device 10 with consumable materials, control cables, power cables, etc. as the device 10 travels through a pipe as further described below. For example, a first reel 50 may provide the welding head 35 of the device 10 with a consumable electrode 58. A second reel 52 may provide the welding head 35 with a flux supply line 60 through which flux may be delivered to the welding head 35 from a flux container (not shown). A third reel 54 may provide the device 10 with a power line 62 for delivering electrical power to various components of the device 10. A fourth reel 56 may provide the device 10 with a control cable 64 for facilitating control of various components of the device 10 from a controller and/or operator interface (not shown). A fifth reel 57 may provide the welding head 35 with a gas line 66 that may supply gas to a pressurized gas cylinder (not shown) on the device 10 for providing compressed gas to the propulsion unit 30, the cross slides 38a, 38b, and/or other forcibly driven components of the device 10. It is contemplated various additional reels may be similarly implemented for providing the device 10 with various other cables, lines, conductors, wires, and hoses.

Although illustrated as reels, it is contemplated that one or more of the electrode, flux, and compressed gas provided by the above-described reels 50, 52, and 57 may instead be carried onboard the device 10, and that the control features facilitated by the control cable 64 provided by the reel 56 may instead be implemented by onboard components of the device. For example, it is contemplated that the device 10 may carry an onboard supply of electrode and/or flux, thereby eliminating the need for the reels 50 and/or 52.

In some embodiments, the device 10 may include a conduit that extends longitudinally through the crawler module 12 for routing one or more of the above-described cables, lines, conductors, wires, and/or hoses. Such a conduit may house the cables, lines, conductors, wires, and hoses and may mitigate tangling or interference thereof with other components of the device 10. In some embodiments, the conduit may be coupled to the crawler module 12 with bearings so that conduit may remain substantially static while the crawler module 12 rotates during operation of the device 10, thereby mitigating twisting of the cables, lines, conductors, wires, and hoses.

The device 10 may also be provided with a wireless communication module for wirelessly receiving and transmitting command and control signals, thereby eliminating the need for the cable 64 and the reel 56. Exemplary command and control signals include on/off signals for powering the device 10 on or off, jog signals for activating the drive wheel 32 to move the device 10 forward or backward through a pipe, various welding control signals for manipulating the position and operation of the welding head 35, etc. Still further, it is contemplated that the device 10 may be provided with an onboard supply of compressed gas, thereby eliminating the need for the reel 57.

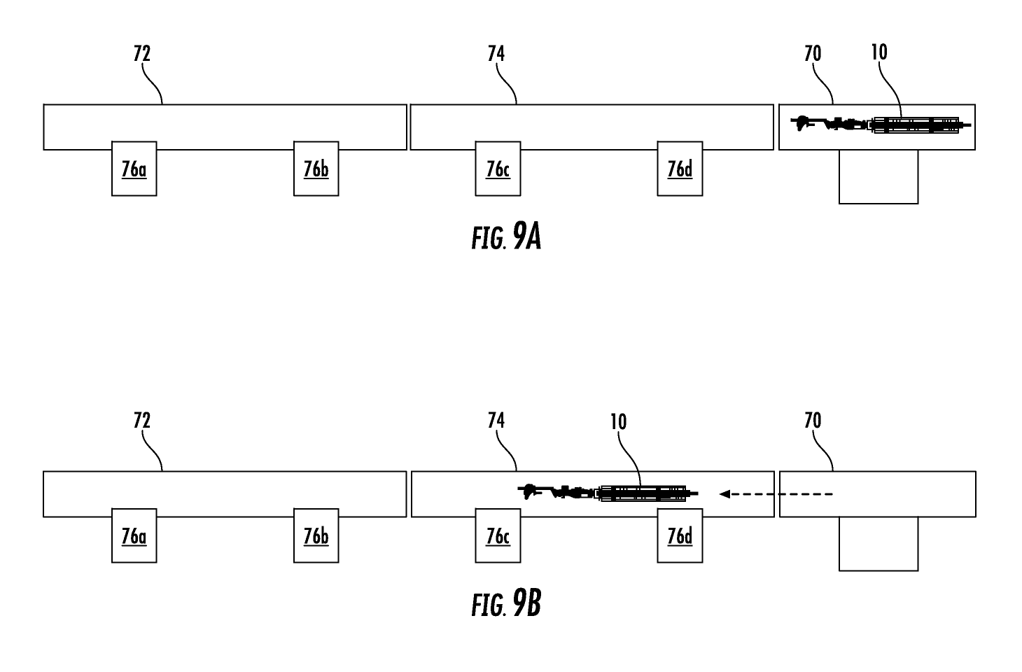

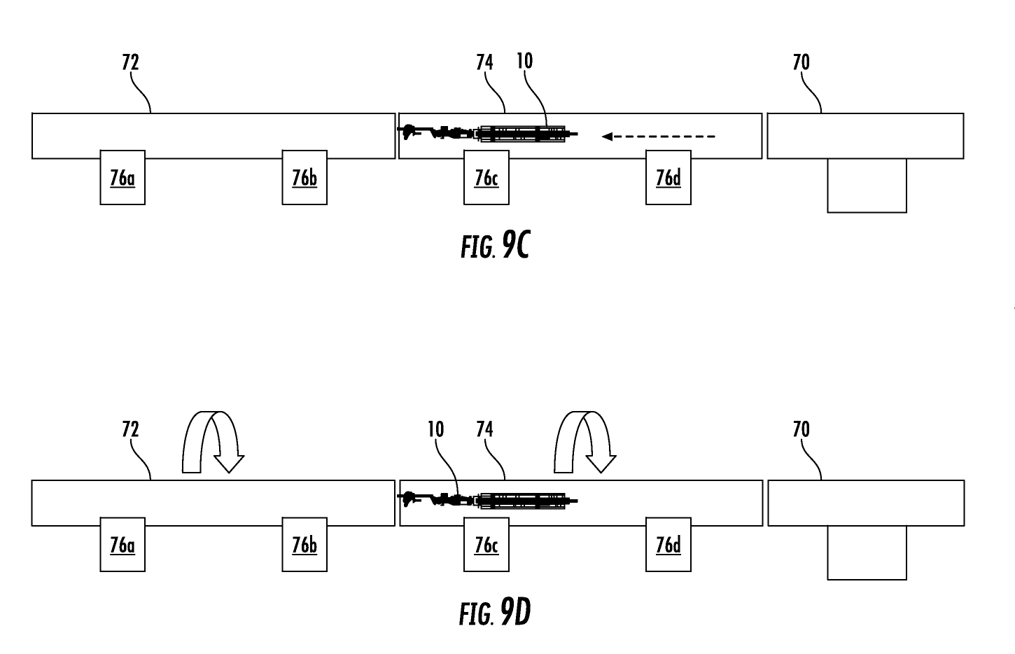

Referring to FIG. 8, a flow diagram illustrating a general exemplary method for operating the device 10 in accordance with the present disclosure is shown. The method will be described in conjunction with the views of the device 10 shown in FIGS. 1-7 and the series of operational steps depicted in FIGS. 9a-9d. Unless otherwise specified, the described method may be effectuated manually at the direction of one or more device operators, and/or automatically at the direction of a properly configured controller, such as through the execution of various software instructions thereby.

At a first step 100, the device 10 may be positioned in a parking station 70 as shown in FIG. 9a with the welding head 35 of the welding module 14 in a 6 o'clock orientation (i.e., directed vertically-downwardly). The parking station 70 may be a section of pipe having a diameter that is substantially equal to the diameters of first and second pipe sections 72, 74 that are to be welded together. The first and second pipe sections 72, 74 may be disposed on pipe rollers 76a, 76b, 76c, and 76d in axial abutment and in concentric alignment with one another and with the parking station 70.

At step 110, the drive mechanisms 22a-c, 23a-c of the roller units 16a, 16b may be operated to radially extend the wheels arms 20a-c, 21a-c as described above, thereby moving the positioning wheels 18a-c, 19a-c into engagement with the interior of the parking station 70 and concentrically centering the device 10 within the parking station 70. At step 120 of the method, the drive mechanism 36 of the propulsion unit 30 may be operated to radially extend the wheel arm 34 as described above, thereby moving the drive wheel 32 into engagement with the interior of the parking station 70.

At step 130, the drive wheel 32 of the propulsion unit 30 may be rotatably driven to propel the device 10 forward through the parking station 70 and into the first pipe 72 as shown in FIG. 9b. The roller units 16a, 16b of the device 10 may allow the device 10 to move smoothly through and between the parking station 70 and the first pipe 72 while maintaining concentric alignment of the device 10 therein. In an alternative embodiment of the exemplary method, the parking station 70 may be omitted and the device 10 may be placed directly into the first pipe 10, such as with a crane or a lift. In such a case, steps 110 and 120 described above would be performed after the device 10 was placed in the first pipe.

At step 140, the propulsion unit 30 may continue to drive the device 10 forward through the first pipe 72 until the welding head 35 of the welding module 14 is moved into longitudinal alignment with, or nearly into longitudinal alignment with, a joint 77 between the first and second pipes 72, 74 as shown in FIG. 9c. The position of the welding head 35 relative to the joint 77 may be manually or automatically determined using the joint detection unit 36 described above. In an alternative embodiment of the exemplary method, the second pipe 74 may be placed on the pipe rollers 76a, 76b in axial abutment and concentric alignment with the first pipe 72 after the welding head 35 has already been moved into a desired welding position at the front edge of the first pipe 72, thereby obviating the need for the joint detection unit 36.

If a desired welding position of the welding head 35 was not or could not been achieved through longitudinal movement of the device 10 by the propulsion unit 30, the cross slides 38a, 38b may, in step 150 of the exemplary method, be operated to effectuate fine lateral and/or vertical movement of the welding head 35 until the desired welding position is achieved. For example, the cross slide 38b may be operated to lower the welding head 35 to a position vertically nearer the joint 77 if necessary. Additionally or alternatively, the cross slide 38a may be operated to adjust the lateral position of the welding head 35 if necessary.

At step 160, with the welding head 35 still in a 6 o'clock orientation, the drive mechanisms 22a-c, 23a-c of the roller units 16a, 16b may be operated to drive the wheel arms 20a-c, 21a-c radially outwardly to increase the force of the wheels positioning 18a-c, 19a-c against the interior of the first pipe 72, thereby increasing the frictional engagement between the positioning wheels 18a-c, 19a-c and the interior of the first pipe 72 and firmly securing the crawler module 12 against longitudinal or rotational movement relative to the first pipe 72. The drive wheel 32 may additionally or alternatively be forced against the interior of the first pipe 72 in a similar manner to secure the position of the crawler module 12 in the pipe 72. Still further, the brake mechanism of the drive wheel 32 (if the drive wheel 32 is provided with a brake mechanism) may also be employed to prevent rotation of the drive wheel 32 to secure the longitudinal position of the crawler module 12 within the first pipe 72.

At step 170, the welding head 35 may be activated to establish an electrical arc between an electrode and the joint 77 and to deposit a desired quantity of flux on the joint 77 to cover the electrical arc. The welding head 35 may thereby begin to deposit weld metal in the joint 77.

At step 180 of the exemplary method, the pipe rollers 76a-d may be activated to rotate the first and second pipes 72, 74 in the same direction and at a substantially identical speed as shown in FIG. 9d. With the position of the crawler module 12 firmly secured relative to the first pipe 72 as described in step 160 above, the crawler module 12 may rotate with the first pipe 72 as the first pipe 72 is rotated by the pipe rollers 76c, 76d. At the same time, the motor 46 coupled to the ring gear 45 of the mounting shaft 40 of the welding module 14 (shown in FIG. 6) may be activated to automatically rotate the welding module 14 at substantially the same speed but in an opposite direction relative to the crawler module 12 (as described above), thereby keeping the welding head 35 in the 6 o'clock orientation above the joint 77. Thus, as the first and second pipes 72, 74 are rotated, the annular joint 77 rotates and passes below the stationary, active welding head 35 which deposits weld metal in the joint 77 that axially joins the first and second pipes 72, 74.

Once the welding head 35 has completed the weld between the first and second pipes 72, 74 (such as may be automatically or manually determined using the joint detection unit 36, for example), the welding head 35 and the pipe rollers 76a-d may, at step 190 of the exemplary method, be deactivated. At step 200 of the method, the crawler module 12 may be unlocked from the first pipe 72 and the device 10 may be driven back into the parking station 70 by reversing the operations performed in steps 110-140 described above.

Although the method has been described in relation to the making of a circumferential weld between a pair of opposing pipe sections, it is contemplated that the device 10 may also be used to create a longitudinal weld seam within a pipe. For example, the welding head 35 may be activated while the device 10 is driven longitudinally through a pipe as described in steps 110-140 above, with the precise position of the welding head 35 being adjusted as described in step 150 above so as to maintain the welding head 35 in the 6 o'clock position above the joint. It is further contemplated that the device 10 may be configured to exclusively perform longitudinal welding. For example, the welding module 14 may be statically (i.e., non-rotatably) coupled to the crawler module 12 in a manner that does not allow relative axial rotation therebetween. Such an embodiment may be lighter, simpler (i.e., requiring fewer and/or less complex parts), and less expensive to manufacture relative to the embodiment of the device 10 described above, making it more appropriate for applications in which circumferential weld seams are unnecessary.

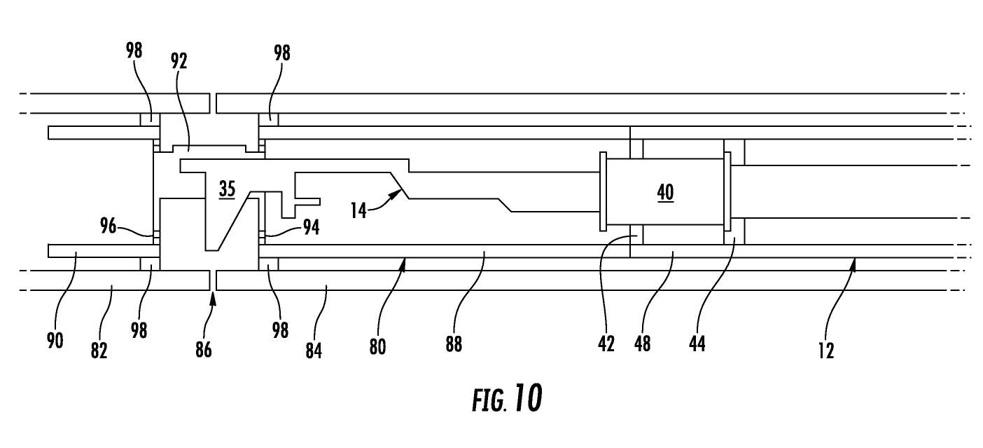

Referring to FIG. 10, a cross sectional side view of an alternative embodiment of the device 10 is shown in which an optional pipe clamping module 80 is attached to the crawler module 14. The pipe clamping module 80 may be implemented for providing pipe sections, such as pipe sections 82, 84 shown in FIG. 10, with radial support adjacent a longitudinal juncture 86 of the pipe sections 82, 84 when the pipe sections 82, 84 are welded together at the juncture 86.

The pipe clamping module 80 may include a generally cylindrical proximal support cage 88 that may be removably or permanently attached to the static frame portion 48 of the crawler module 14, such as with mechanical fasteners or welds. Alternatively, the pipe clamping module 80 may be integral with the static frame portion 48 of the crawler module 14. The proximal support cage 88 may extend forward from the static frame portion 48 over a majority of the welding module 14 to a forward-most terminus that is longitudinally short of the welding head 35.

The pipe clamping module 80 may further include a generally cylindrical distal support cage 90 that may be coaxial with, and disposed on a longitudinally-opposite side of the welding head 35 from, the proximal support cage 88. The distal support cage 90 may be connected to the proximal support cage 88 by a bridge member 92. The bridge member 92 may longitudinally span, and may be disposed laterally adjacent, the welding head 35. It is contemplated that in some embodiments the bridge member 92 may be attached to the welding head 35. The bridge member 92 may be attached to the proximal support cage 88 and the distal support cage 90 by respective annular roller bearing joints 94, 96 that allow free rotation of the bridge member 92 relative to the proximal support cage 88 and the distal support cage 90 about a common longitudinal axis as further described below.

The pipe clamping module 80 may further include clamping mechanisms 98 that may be integral with the proximal support cage 88 and the distal support cage 90. The clamping mechanisms 98 may include a plurality of circumferentially-spaced pads, tracks, feet or the like that may be radially extended and retracted relative to the proximal support cage 88 and the distal support cage 90, such as via motorized actuation, to selectively engage and disengage the interior surfaces of the pipe sections 82, 84. For example, the clamping mechanisms 98 may be moved between a retracted position, wherein the clamping mechanisms 98 are positioned radially near or within the proximal support cage 88 and the distal support cage 90, and a deployed position (shown in FIG. 10), wherein the clamping mechanisms 98 are radially extended from the proximal support cage 88 and the distal support cage 90 to firmly engage and radially support the pipe sections 82, 84 at positions adjacent the juncture 86. In some embodiments, the pipe clamping module 80 may additionally or alternatively include clamping mechanisms that may be longitudinally extended and retracted, such as for engaging longitudinal ends of pipe sections.

When the device 10 is moved into position to weld the pipe sections 82, 84 together, with the welding head 35 positioned above the juncture 86 as shown in FIG. 10, the clamping mechanisms 98 may be moved to the deployed position to engage and internally clamp the pipe sections 82, 84. When the pipe sections 82, 84 are rotated about their axes during a welding operation (as described above), the proximal support cage 88 and the distal support cage 90 may rotate with the pipe sections 82, 84 by virtue of frictional engagement between the clamping mechanisms 98 and the pipe sections 82, 84. However, since the bridge member 92 is able to rotate freely about its axis relative to the proximal support cage 88 and the distal support cage 90, the bridge member 92 may remain substantially stationary as the pipe sections 82, 84 and the proximal support cage 88 and the distal support cage 90 are rotated. The pipe clamping module 80 may thereby provide the pipe sections 82, 84 with radial support on either longitudinal side of the juncture 86 during a welding operation without the bridge member 92 interfering with the weld head 35.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A welding device comprising:
a crawler module having a propulsion unit configured to controllably drive the device longitudinally through a pipe; and
a welding module rotatably coupled to the crawler module and having a welding head mounted thereon, wherein the welding module automatically rotates in an opposite direction and at a same rotational speed relative to a direction and rotational speed of the crawler module to maintain an angular position of the welding head.

2. The welding device of claim 1, wherein the crawler module further includes a roller unit having a plurality of wheels that are radially extendable and retractable relative to a static frame, wherein the wheels are adapted to engage an interior of a pipe and concentrically center the device within the pipe while allowing the unit to move longitudinally through the pipe.

3. The welding device of claim 2, wherein each wheel is rotatably mounted to a respective wheel arm that is pivotably connected to the static frame, each wheel arm being coupled to a drive mechanism that is adapted to radially extend and retract the wheel arm relative to the static frame.

4. The welding device of claim 1, wherein the propulsion unit comprises a rotatably driven drive wheel that is radially extendable and retractable relative to a static frame.

5. The welding device of claim 4, wherein the drive wheel is rotatably mounted to a wheel arm that is pivotably connected to the static frame, the wheel arm being coupled to a drive mechanism that is adapted to radially extend and retract the drive wheel arm relative to the static frame.

6. The welding device of claim 1, wherein the crawler module further includes a motor coupled to a ring gear on the welding module, the motor operatively coupled to a controller that is configured to automatically operate the motor to rotate the welding module at the same speed and in an opposite direction relative to the crawler module.

7. The welding device of claim 1, wherein the welding module further includes a joint detection unit mounted adjacent the welding head that is configured to facilitate detection of a joint to be welded.

8. The welding device of claim 7, wherein the joint detection unit comprises a camera.

9. The welding device of claim 7, wherein the joint detection unit comprises a laser.

10. The welding device of claim 1, wherein the welding module further includes a cross slide coupled to the welding head, the cross slide configured to facilitate controllable movement of the welding head in at least one of a direction perpendicular to, or in a direction parallel with, a direction of movement of the device through the first pipe.

11. The welding device of claim 1, further comprising a clamping module connected to the crawler module and extending over the welding module, the clamping module including a first plurality of clamping mechanisms on a first longitudinal side of the welding head and a second plurality of clamping mechanisms on a second longitudinal side of the welding head opposite the first side.

12. A method for welding pipes using a pipe crawling welding device, the method comprising:
positioning a welding head of the device adjacent an annular joint between axially abutting first and second pipes;
securing a crawler module of the device against rotational movement relative to the first pipe;
activating the welding head;
rotating the first and second pipes at a first speed and in a first direction about a common axis; and
rotating the welding head about the common axis at a second speed that is equal to the first speed and in a second direction that is opposite the first direction to maintain an angular position of the welding head.

13. The method of claim 12, further comprising radially extending wheels from the crawler module into engagement with the interior of the first pipe to concentrically center the device within the first pipe while allowing longitudinal movement of the device through the first pipe.

14. The method of claim 13, further comprising increasing a force between the wheels and the interior of the first pipe to secure the crawler module against rotational movement relative to the first pipe.

15. The method of claim 12, further comprising radially extending a drive wheel from the crawler module into engagement with the interior of the first pipe and rotatably driving the drive wheel to propel the device longitudinally through the first pipe.

16. The method of claim 15, further comprising actuating a brake pad or a brake mechanism of the drive wheel to prevent rotation of the drive wheel and mitigate longitudinal movement of the device relative to the first pipe.

17. The method of claim 12, further comprising:
positioning the device in a parking station comprising a third pipe;
moving the first pipe into axial abutment and concentric alignment with the parking station;
moving the second pipe in axial abutment and concentric alignment with the first pipe; and
moving the device longitudinally from the parking station into the first pipe;

18. The method of claim 17, further comprising moving the device longitudinally through the first pipe until the welding head is positioned adjacent the joint.

19. The method of claim 12, further comprising using a joint detection unit mounted adjacent the welding head to determine a position of the welding head relative to the joint.

20. The method of claim 12, further comprising radially extending clamping mechanisms from the device to engage and radially support the first pipe and the second pipe at a longitudinal positions adjacent the annular joint.
